(19) United States
(12) Patent Application Publication
(10) Pub. No.: US 2022/0361493 A1
(43) Pub. Date: Nov. 17, 2022

(54) HERBICIDE COMPOSITION

(71) Applicants: UPL CORPORATION LIMITED, Port Louis (MU); UPL EUROPE LTD, Warrington, Chesire (GB)

(72) Inventors: Carlos Eduardo FABRI, Port Louis (MU); Rafael Henriq PEREIRA, Port Louis (MU); Ferdinando Marcos Lima SILVA, CEP (BR); Giuvan LENZ, CEP (BR)

(73) Assignees: UPL CORPORATION LIMITED, Port Louis (MU); UPL EUROPE LTD, Warrington, Chesire (GB)

(21) Appl. No.: 17/765,839

(22) PCT Filed: Oct. 1, 2020
(86) PCT No.: PCT/IB2020/059197

§ 371 Date: Apr. 1, 2022

(30) Foreign Application Priority Data
Oct. 1, 2019 (IN) 201941039823

(51) Int. Cl. A01N 37/26; A01N 43/84; A01N 43/653; A01N 43/40; A01N 35/06; A01N 43/60; A01N 43/66; A01N 47/30; A01N 47/36; A01N 33/18; A01P 13/00

(52) U.S. Cl. CPC A01N 37/26; A01N 43/84; A01N 43/653; A01N 43/40; A01N 35/06; A01N 43/60; A01N 43/66; A01N 47/30; A01N 47/36; A01N 33/18; A01P 13/00

(57) ABSTRACT

Disclosed herein synergistic herbicidal combination of shoot growth inhibitor herbicides with root growth inhibitors or cell membrane disruptors and a method of controlling weeds using said combinations.

### FIELD OF INVENTION

The present invention relates to herbicidal combinations and to a method for controlling weeds using the same. More specifically, the subject of this invention relates to combinations of shoot growth inhibitor herbicides with root growth inhibitors or cell membrane disruptors and a method for controlling weeds using the same.

### BACKGROUND OF INVENTION

Herbicides are pesticides useful for killing or controlling unwanted plants. Generally, there are two kinds of herbicides-selective and non-selective. Selective herbicides kill certain target weeds while leaving the desired crop relatively unharmed while non-selective herbicides kill both the weeds and crops. Profitable crop production depends on effective weed control. The weeds can reduce field crop yields by competing for water, sunlight and nutrients. In today's crop production systems, starting off with a good burn-down program is a must as it helps to achieve maximum initial crop growth and reduce weed interference during early stages of the crop cycle. Since the weed-crop competition is critical during the early stages of crop cycle, the weed interference at early stage has a direct impact on the yield of the crop.

An effective weed control can be achieved by usage of herbicides appropriately. The activity of herbicides can be enhanced in various ways to achieve the maximum benefit. One of the ways is to use combinations. However, identifying appropriate combinations, their agrochemical application rates and ratio of the combinations is essential to achieve efficacious control, which is not straight forward. The selection of a particular formulation type is more cumbersome for an agrochemical combination. Thus, herbicides play an important role for weed control in crop production. Applying combinations of herbicidal compounds may enhance the herbicidal effectiveness.

Propisochlor has been tested on a very large number of crops; it has been found to be very interesting for many of the crops tested, particularly for maize, sunflower and rapeseed. The weeds that occur on these crops and on which propisochlor allows an interesting control are mainly:—grasses: Echinochloa crus-galli; Setaria sp; Digitaria sanguinalis; Apera spica venti; Poa annua; Sorghum halepense; broadleaf weeds: Capsella Bursa Pastoris; Amaranthus retroflexus; Chenopodium spp.; Matricaria spp; Galium Aparine. Propisochlor can be applied at different key stages of the crop, i.e. pre-planting (with or without incorporation into the soil), and post-sowing/pre-emergence stage.

There are various combinations of propisochlor with other actives—known in the art, however present inventors here proposed a composition comprising certain shoot growth inhibitor herbicides combined with certain root growth inhibitors. The efficacy of these herbicides against harmful weeds in the crop plants depends on the application rate, the formulation ingredients, the harmful weeds to be controlled, the climatic conditions and the soil conditions.

However, there remains a great need for improved broadleaf and grassy weed control compositions and a method of controlling such noxious vegetation in pre and post emergence without adversely affecting desirable plants and which reduces the amount of chemical herbicidal agent necessary to obtain the acceptable weed control.

### SUMMARY OF INVENTION

In one aspect, the present invention provides a herbicidal combination comprising:
(a) at least one shoot growth inhibitor; and
(b) one least one root growth inhibitor- or cell membrane disruptor-.

In another aspect, the present invention provides a herbicidal combination comprising:
(a) at least one shoot growth inhibitor belonging to chloroacetamide group; and
(b) at least one root growth inhibitor, Protoporphyrinogen Oxidase (PPO) inhibitor, Acetyl CoA Carboxylase (ACCase) inhibitor- or photo system II inhibitor.

In another aspect, the present invention provides a herbicidal combination comprising:
(a) at least one shoot growth inhibitor; and
(b) at least one root growth inhibitor.

In another aspect, the present invention provides a herbicidal composition comprising:
(a) at least one shoot growth inhibitor; and
(b) at least one cell membrane disruptor.

In an aspect, the present invention provides a herbicidal composition comprising:
(a) at least one shoot growth inhibitor;
(b) at least one root growth inhibitor or cell membrane disruptor; and
(c) at least one agrochemically acceptable excipient.

In another aspect, the present invention may provide a method of controlling weeds at a locus, said method comprising applying to weed or to their locus or to crop a herbicidal combination comprising:
(a) at least one shoot growth inhibitor; and
(b) at least one root growth inhibitor or cell membrane disruptor.

Yet another aspect of the present invention may provide a method of increasing yield in a crop by application to locus or directly to the crop of a combination comprising:
(a) at least one shoot growth inhibitor; and
(b) at least one root growth inhibitor or cell membrane disruptor.

Another aspect of the present invention may provide a method of improving plant health, said method comprising application to the weed or plant or locus of the plant a combination comprising:
(a) at least one shoot growth inhibitor; and
(b) at least one root growth inhibitor or cell membrane disruptor.

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

The term herbicide, as used herein, shall mean an active ingredient that kills, controls or otherwise adversely modifies the growth of plants. As used herein, a herbicidally effective or vegetation controlling amount is an amount of active ingredient that causes a “herbicidal effect,” i.e., an adversely modifying effect and includes deviations from natural development, killing, regulation, desiccation, retardation.

The terms “plants” and “vegetation” include, but are not limited to, germinant seeds, emerging seedlings, plants emerging from vegetative propagules, and established vegetation. The term “weed” refers to unwanted vegetation and includes any plant which grows where it is not wanted, including pesticide resistant plants.

Typically, the combinations/compositions of the present invention are applied to the targeted weed or to their locus or to the crop/plant. The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus. The said locus could be a weed, an area adjacent to the weed, soil adapted to support growth of the weed, a root of the weed and/or foliage of the weed.

In any aspect or embodiment described hereinbelow, the phrase comprising may be replaced by the phrases “consisting of” or “consisting essentially of” or “consisting essentially of”. In these aspects or embodiment, the combination or composition described includes or comprises or consists of or consists essentially of or consists substantially of the specific components recited therein, to the exclusion of other fungicides or insecticide or plant growth promoting agents or adjuvants or excipients not specifically recited therein.

It was surprisingly found that a synergistic interaction was observed when certain shoot growth inhibitor herbicides were combined with certain—root growth inhibitors—.

Chloroacetamides-target the long chain fatty acid synthesis in the membrane, and thus prevent the formation of cell membranes. —

One example of root growth inhibitors according to the present invention is microtubule assembly inhibitors.

Thus, in this embodiment, the present invention provides a combination comprising at least one shoot growth inhibitor- and at least one microtubule assembly inhibitor. It has also been found that these shoot growth inhibitors, due to their cell membrane targeting activity, demonstrate synergistic activity in the presence of another cell membrane disruptors.

For example, cell membrane disruptors that are used with shoot growth inhibitors are the PPO inhibitors, which oxidize the lipids and proteins of the cell membranes causing cellular disintegration and eventual plant death.

Thus, in this embodiment, the present invention provides a combination comprising at least one shoot growth inhibitor and at least one PPO inhibitor.

In another embodiment, cell membrane disruptors that are used with shoot growth inhibitors are lipid synthesis inhibitors or ACCase inhibitors, which block the production of phospholipids necessary for cell structure and function.

Thus, in this embodiment, the present invention provides a combination comprising at least one shoot growth inhibitors and at least one ACCase inhibitor.

In another embodiment, cell membrane disruptors that are used with shoot growth inhibitors are the photosystem II inhibitors.

These photosystem II inhibitors initiate their activity by inhibiting the photosynthetic pathway, which ultimately leads to the generation of triplet-chlorophyll and singlet oxygen, which causes lipid peroxidation. This lipid peroxidation causes the loss of chlorophyll and other constituents from the cell membranes, causing the cells to disintegrate and die.

Thus, in this embodiment, the present invention provides a combination comprising at least one shoot inhibitor and at least one photosystem II inhibitor.

Accordingly, in an aspect, the present invention presents a herbicidal combination comprising:
(a) at least one shoot growth inhibitor; and
(b) at least one second herbicide selected from the group consisting of root growth inhibitors, PPO inhibitors, ACCase inhibitors, and photosystem II inhibitors.

In one embodiment the shoot growth inhibitor is a herbicide belonging to chloroacetamide compound.

Therefore, in one aspect, the present invention may provide a herbicidal combination comprising:
(a) at least one herbicide belonging to chloroacetamide compound; and
(b) at least one second herbicide selected from root growth inhibitors, Protoporphyrinogen Oxidase (PPO) Inhibitors, Acetyl CoA Carboxylase (ACCase) Inhibitors and photosystem II inhibitors.

The present invention relates to a herbicidal composition comprising at least one herbicide belonging to chloroacetamide compound and at least one second herbicide selected from root growth inhibitors, Protoporphyrinogen Oxidase (PPO) Inhibitors, Acetyl CoA Carboxylase (ACCase) Inhibitors and photosystem II inhibitors for controlling weeds.

In an embodiment, the chloroacetamide compound is propisochlor, which penetrates through the underground organs of weeds during germination or at the seedling stage. On the one hand, it inhibits the synthesis of proteins and nucleic acids, on the other hand it inhibits root growth. The reduction in osmotic potential resulting from these actions causes the rapid death of weeds.

In an embodiment, the second herbicide is one or more herbicide compound, or its salts, isomer and derivatives selected from the group comprising
(i) Root growth inhibitors,
(ii) Protoporphyrinogen Oxidase (PPO) Inhibitors,
(iii) Acetyl CoA Carboxylase (ACCase) Inhibitors, and
(iv) Photosystem II inhibitors.

The composition of the invention may further comprise other subsequent active ingredients such as other herbicides, antidotes, fungicides, insecticides, acaricides, fertilizers.

Examples of a combination/composition in present composition according to the invention are, but are not limited to, described hereinafter.

In an embodiment the present invention provides a composition comprising
(a) Propisochlor; and
(b) at least one root growth inhibitor selected from microtubule assembly inhibitors.

In an embodiment the present invention provides a composition comprising:
a) Propisochlor; and
b) at least one second herbicide selected from Protoporphyrinogen Oxidase (PPO) Inhibitors.

In an embodiment the PPO inhibitor is selected from one or more of diphenylether, N-phenylphthalimide, phenylpyrazole oxadiazole, thiadiazole, triazolinone, oxazolidinedione and pyrimidinedione herbicides.

In an embodiment the PPO inhibitor is selected from one or more of acifluorfen, fomesafen, lactofen, flumiclorac, flumioxazin, Orizalina, carfentrazone, fluthiacet-ethyl and azafenidin, benzfendizone, bifenox, butafenacil, carfentrazone, carfentrazone-ethyl, chlomethoxyfen, cinidon-ethyl, fluazolate, flufenpyr-ethyl, flumiclorac-pentyl, fluoroglycofen-ethyl, fluthiacet-methyl, fomesafen, halo safen, lactofen, oxadiargyl, oxadiazon, oxyfluorfen, pentoxazone, profluazol, pyraclonil, pyraflufen-ethyl, thidiazimin, trifludimoxazin and tiafenacil.

In an embodiment the present invention provides a composition comprising
a) Propisochlor; and
b) at least one second herbicide selected from acifluorfen-sodium, fomesafen, lactofen, oxyfluorfen, flumiclorac, flumioxazin, oxadiazon, fluthiacet-ethyl, carfentrazone and sulfentrazone.

In an embodiment the present invention provides a composition comprising
a) Propisochlor; and
b) Sulfentrazone.

In still another embodiment, present invention provides combination of Propisochlor and Sulfentrazone, wherein ratio of Propisochlor to Sulfentrazone is from 5:1 to 20:1, preferably from 5:1 to 15:1, more preferably from 5:1 to 10:1.

In an embodiment the present invention provides a composition comprising propisochlor and flumioxazin.

In still another embodiment, present invention provides combination of Propisochlor and Flumioxazin, wherein ratio of Propisochlor to Flumioxazin is from 15:1 to 30:1, preferably from 20:1 to 30:1, more preferably from 25:1 to 30:1.

In an embodiment the present invention provides a composition comprising
a) Propisochlor; and
b) at least one second herbicide selected from Acetyl CoA Carboxylase (ACCase) Inhibitors.

The Acetyl CoA Carboxylase (ACCase) Inhibitor is selected from one or more of Aryloxyphenoxypropionates (FOPs), Cyclohexanediones (DIMs) and Phenylpyrazoline.

The Acetyl CoA Carboxylase (ACCase) Inhibitor is selected from the group consisting of clodinafop-propargyl, cyhalofop-butyl, diclofop-methyl, fenoxaprop-P-ethyl, fluazifop-P-butyl, haloxyfop-etotyl, haloxyfop-methyl, haloxyfop-P-methyl, quizalofop-P-ethyl, propaquizafop, metamifop, quizalofop-P-tefuryl, alloxydim, butroxydim, clethodim, cycloxydim, profoxydim, sethoxydim, tepraloxydim, tralkoxydim and pinoxaden.

In an embodiment the present invention provides a composition comprising
a) Propisochlor; and
b) Clethodim.

In still another embodiment, present invention provides combination of Propisochlor and Clethodim, wherein ratio of Propisochlor to Clethodim is from 1:1 to 10:1, preferably from 5:1 to 10:1.

In an embodiment the present invention provides a composition comprising
a) Propisochlor; and
b) Haloxyfop-P-methyl

In still another embodiment, present invention provides combination of Propisochlor and haloxyfop-P-methyl, wherein ratio of hropisochlor to haloxyfop-P-methyl is from 1:1 to 20:1, preferably from 5:1 to 20:1.

In an embodiment the present invention provides a composition comprising
a) Propisochlor; and
b) Quizalafop-P-methyl

In still another embodiment, present invention provides combination of Propisochlor and Quizalafop-P-methyl, wherein ratio of Propisochlor to Quizalafop-P-methyl is from 1:1 to 20:1, preferably from 5:1 to 20:1.

In an embodiment the present invention provides a composition comprising
a) Propisochlor; and
b) at least one second herbicide selected from photosystem II inhibitor.

The photosystem II inhibitor is selected from the group consisting of

(i) a phenylcarbamate herbicide;

(ii) a triazine herbicide;

(iii) a triazinone herbicide;

(iv) an uracil herbicide;

(v) a benthiadiazole herbicide;

(vi) a nitrile herbicide;

(vii) an urea herbicide; and

(viii) thiadiazolylurea herbicides.

In an embodiment, the photosystem II inhibitor is a phenylcarbamate herbicide.

In an embodiment, the phenylcarbamate herbicide is selected from the group consisting of barban, BCPC, carbasulam, carbetamide, CEPC, chlorbufam, chlorpropham, CPPC, desmedipham, phenisopham, phenmedipham, phenmedipham-ethyl, propham and swep.

In an embodiment, the phenylcarbamate herbicide is selected from the group consisting of chlorpropham, desmedipham, phenmedipham, and phenmedipham-ethyl.

In an embodiment, the phenylcarbamate herbicide is chlorpropham.

In an embodiment, the phenylcarbamate herbicide is desmedipham.

In an embodiment, the phenylcarbamate herbicide is phenmedipham.

In an embodiment, the phenylcarbamate herbicide is phenmedipham-ethyl.

In an embodiment, the photosystem II inhibitor is a triazine herbicide.

In an embodiment, the triazine herbicide is selected from the group consisting of dipropetryn, fucaojing, trihydroxytriazine, atrazine, chlorazine, cyanazine, cyprazine, eglinazine, ipazine, mesoprazine, procyazine, proglinazine, propazine, sebuthylazine, simazine, terbuthylazine, trietazine, indaziflam, triaziflam, atraton, methometon, prometon, secbumeton, simeton, terbumeton, ametryn, aziprotryne, cyanatryn, desmetryn, dimethametryn, methoprotryne, propmetryn, simetryn, and terbutryn.

In an embodiment, the triazine herbicide is atrazine.

In an embodiment, the triazine herbicide is ametryn.

In an embodiment, the photosystem II inhibitor is a triazinone herbicide.

In an embodiment, the triazinone herbicide is selected from the group consisting of ametridione, amibuzin, ethiozin, hexazinone, isomethiozin, metamitron, metribuzin and trifludimoxazin.

In an embodiment, the triazinone herbicide is hexazinone.

In an embodiment, the triazinone herbicide is metamitron.

In an embodiment, the triazinone herbicide is metribuzin.

In an embodiment, the photosystem II inhibitor is a uracil herbicide.

In an embodiment, the uracil herbicide is selected from the group consisting of benzfendizone, bromacil, butafenacil, flupropacil, isocil, lenacil, terbacil and tiafenacil.

In an embodiment, the uracil herbicide is bromacil.

In an embodiment, the photo system II inhibitor is a benzothiazole herbicide or a benzothiadiazole herbicide.

In an embodiment, the benzothiazole herbicide is selected from the group consisting of benazolin, benzthiazuron, fenthiaprop, mefenacet, and methabenzthiazuron.

In an embodiment, the photosystem II inhibitor is a benzothiadiazole herbicide.

In an embodiment, the benzothiadiazole herbicide is bentazone or bentazone-sodium.

In an embodiment, the photosystem II inhibitor is a nitrile herbicide.

In an embodiment, the nitrile herbicide is selected from the group consisting of bromobonil, bromoxynil, chloroxynil, cyclopyranil, dichlobenil, iodobenil, ioxynil and pyraclonil.

In an embodiment, the nitrile herbicide is bromoxynil.

In an embodiment, the photosystem II inhibitor is a urea herbicide.

In an embodiment, the urea herbicide is a phenylurea herbicide.

In an embodiment, the phenylurea herbicide is selected from the group consisting of anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiruon, methyldymuron, metobenzuron, metobromuron, metoxuron, monolinuron, monuron, neburon, parafluron, phenobenzuron, siduron, tetrafluron, and thidiazuron.

In an embodiment, the phenylurea herbicide is diuron.

In an embodiment, the phenylurea herbicide is linuron.

In an embodiment, the photosystem II inhibitor is selected from the group consisting of chlorpropham, desmedipham, phenmedipham, phenmedipham-ethyl, atrazine, hexazinone, metamitron, metribuzin, bromacil, bentazone, bentazone-sodium, bromoxynil, diuron, and linuron.

In an embodiment, the thiadiazolylurea herbicides is selected from buthiuron, ethidimuron, tebuthiuron, thiazafluron and thidiazuron.

In an embodiment the present invention provides a composition comprising
a) Propisochlor; and
b) Diuron.

In still another embodiment, present invention provides combination of Propisochlor and Diuron, wherein ratio of Propisochlor to Diuron is from 0.50:1 to 10:1, preferably from 0.25:1 to 5:1, more preferably from 0.25:1 to 3:1.

In an embodiment the present invention provides a composition comprising
a) Propisochlor; and
b) Tebuthiuron.

In still another embodiment, present invention provides combination of Propisochlor and Tebuthiuron, wherein ratio of Propisochlor to Tebuthiuron is from 0.50:1 to 10:1, preferably from 1:1 to 5:1, more preferably from 1:1 to 3:1.

In an embodiment the present invention provides a composition comprising
a) Propisochlor; and
b) Hexazinone.

In still another embodiment, present invention provides combination of Propisochlor and Hexazinone, wherein ratio of Propisochlor to Hexazinone is from 1:1 to 20:1, preferably from 1:1 to 15:1.

In an embodiment the present invention provides a composition comprising
a) Propisochlor; and
b) Thidiazuron.

In an embodiment the present invention provides a composition comprising
(c) Propisochlor; and
(d) at least one root growth inhibitor selected from microtubule assembly inhibitors.

In an embodiment, the microtubule assembly inhibitor is selected from benzamide, benzoic acid, nitroaniline and pyridine herbicides.

In another embodiment, the microtubule assembly inhibitor is selected from Benzamide, Benzoic acid, Dinitroaniline, Phosphoroamidate and Pyridine herbicides.

In an embodiment, the microtubule assembly inhibitor is selected from benfluralin, butralin, dinitramine, oryzalin, pendimethalin, trifluralin, Propyzamide, DCPA, Pendimethalin, Ethalfluralin, Oryzalin, Trifluralin, Prodiamine, Dithiopyr, Thiazopyr, or methyl butamiphos.

In an embodiment the present invention provides a composition comprising
a) Propisochlor; and
b) Trifluralin.

In still another embodiment, present invention provides combination of Propisochlor and Trifluralin, wherein ratio of Propisochlor to Trifluralin is from 0.5:1 to 10:1, preferably from 1:1 to 7:1, more preferably from 1:1 to 4:1.

In an embodiment the present invention provides a composition comprising
a) Propisochlor; and
b) Oryzalin.

In an aspect, the present invention the herbicidal combination described above further comprising a third active.

Accordingly, the present invention provides a composition comprising
(a) at least one shoot growth inhibitor; and
(b) at least one second herbicide selected from the group consisting of root growth inhibitors, PPO inhibitors, ACCase inhibitors, and photosystem II inhibitors and
(c) at least one third herbicide.

In an embodiment, the third active of the present composition may be those selected from but not limited to herbicide, insecticide, fungicide, biological agent, plant growth activator, fertilizers or combinations thereof.

Exemplary third herbicides that may be combined with the combination of the present invention may be selected from but not limited to herbicides belonging to classes such as EPSP synthase inhibitors, synthetic auxins, auxin transport inhibitors, glutamate synthase inhibitors, HPPD inhibitors, lipid synthesis inhibitors, long chain fatty acid inhibitors, Carotenoid Biosynthesis Inhibitors, Cellulose Inhibitors, Glutamine Synthesis Inhibitors, Photo system I (PSI) Electron Diverter, as well as herbicides with unknown modes of action.

Example of other herbicides that may be combined with the combination of the present invention may be selected from but not limited to, topramezone, Orthosulfamuron, Pinoxaden, Metamifop, Pyrimisulfan, Tembotrione, Thiencarbazone methyl, Flucetosulfuron, Aminopyralid, Pyrasulfotole, Saflufenacil, Pyroxsulam, Pyroxasulfone, Pyraclonil, Indaziflam, Fenquinotrione, Florpyrauxifen-benzyl, Tiafenacil, Cinmethylin, Lancotrione-Sodium, Bixlozone, Trifludimoxazin, Cyclopyrimorate, Methiozolin, Aminocyclopyrachlor, Metazosulfuron, Ipfencarbazone, Fenoxasulfone, Bicyclopyrone, Triafamone, Halauxifen methyl, Tolpyralate or combinations thereof.

In an aspect the present invention provides a herbicidal composition for controlling weeds comprising
(a) at least one shoot growth inhibitor;
(b) at least one second herbicide selected from the group consisting of root growth inhibitors, PPO inhibitors, ACCase inhibitors, and photosystem II inhibitors and
(c) at least one third herbicide along with at least one agrochemically acceptable excipient.

The compositions of the present disclosure can be employed in combination with known herbicide safeners, such as benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148 and N-phenyl-sulfonylbenzoic acid amides, to enhance their selectivity.

Optionally, a composition can include an adjuvant. An adjuvant may be used with the composition to enhance or improve herbicidal performance. Adjuvants may be added to the composition at the time of formulation, or by the applicator to the spray mix just prior to treatment. Adjuvants include surfactants, compatability agents, anti-foaming agents and spray colorants (dyes), and drift control agents. In certain embodiments, the adjuvant is an ethoxylated propoxylated fatty amine or a polyether-polymethylsiloxane-copolymer.

As disclosed herein, the compound combinations, in addition to being well tolerated by crops, have herbicidal activities and can be used in a variety of crops for selectively controlling weed. Non-limiting examples of crops include maize, wheat, sugar cane, barley, rice, citrus, palm trees, pineapple, cucurbits, beans, soybeans, agave, cassava, turf and pasture.

The compound combinations can also be used for controlling undesired vegetation in non-crop areas, e.g. fallow agricultural land. The term “non-crop area” used herein refers to areas where a crop, or any intentionally planted vegetation, is not grown. The term “fallow agricultural land” used herein refers to a piece of land where no crop or pasture is growing. A fallow agricultural land that is not used for crops, may be left unused in order to restore its natural fertility.

In various embodiments, the herbicidal activity of a composition according to the invention exceeds the total of the activities of the individual active compounds. If there are two active compounds, the activity will be greater than the same of the single active compound alone. Thus, in various embodiments, herbicidal compositions include compositions synergistic for control of one or more weeds.

The compositions of the invention have been found to be active herbicides in possessing herbicidal activity against one or more species of weeds. In the broadest sense, the term “weed” refers to plants which grow in locations in which they are not desired. In other words, a weed is a plant in which in the context of a crop is undesirable due to competition for water, nutrients, sunlight, soil, etc.

The compositions of the invention can be used, for example, in control of one or more of following plants (weeds):

Monocotyledonous weeds include the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria, Sorghum.

Dicotyledonous weeds include the genera: Abutilon, Amaranthus, Ambrosia, Anoda, Anthemis, Aphanes, Atriplex, Bellis, Bidens, Capsella, Carduus, Cassia, Centaurea, Chenopodium, Cirsium, Convolvulus, Croton, Datura, Desmodium, Emex, Erysimum, Euphorbia, Galeopsis, Galinsoga, Galium, Hibiscus, Ipomoea, Kochia, Lamium, Lepidium, Lindernia, Matricaria, Mentha, Mercurialis, Merremia, Momordica, Mullugo, Myosotis, Papaver, Pharbitis, Plantago, Polygonum, Portulaca, Ranunculus, Raphanus, Ricinus, Rorippa, Rotala, Rumex, Salsola, Senecio, Sesbania, Sida, Sinapis, Solanum, Sonchus, Sphenoclea, Stellaria, Stizolobium, Taraxacum, Thlaspi, Trifolium, Urtica, Veronica, Viola, Xanthium.

The use of the active compound combinations according to the invention is in no way restricted to these genera, but also extends in the same manner to other plants. Depending on the concentration, the herbicidal compositions are suitable for selective weed control in crops, for example, cereals, rice, maize, sorghum, sugar cane, cotton, canola, soya, turf, barley, potato, sweet potato, sunflower, rye, oats, wheat, corn, soybean, sugar beet, safflower, alfalfa, cassava, cucurbits, pineapple and pastures.

Specific weed species encountered in corn include, but not limited to, Ixophorus unisetus, Amaranthus hybridu, Ipomoea purpurea, and Sicyos angulata. Specific weed species encountered in sugar cane include, but not limited to, Acalypha sp., Boerhavia erecta, Trianthema portulacastrum, Amaranthus hybridus, Amaranthus lividus, Brachiaria decumbens Eleusine indica Cenchrus echinatus Ipomoea grandifolia or Commelina benghalensis.

In particular embodiments, a synergistic effect of the compound combinations according to the invention is present. As used herein, the term “synergism” means that the herbicidal action of the active compound combination exceeds the action of the active compounds when applied individually on a given weed, either pre- or post-emergent.

The herbicidal compositions can be in customary formulations, such as solutions, emulsions, wettable powders, suspensions, powders, dusts, pastes, soluble powders, granules, suspo-emulsion concentrates, emulsifiable concentrate, oil spray, aerosol, natural and synthetic materials impregnated with active compound, and very fine capsules in polymeric substances. In certain embodiments, the compositions is in a form of an emulsifiable concentrate, wettable powder, granule, dust, oil spray or aerosol.

These formulations can be produced, for example by mixing the active compounds with agrochemically acceptable ingredients which include but not limited to, extenders, that is liquid carriers and/or solid carriers, one or more dispersants, wetting agents, fillers, surfactants, anticaking agents, pH-regulating agents, preservatives, biocides, antifoaming agents, colorants and other formulation aids. In the case of the use of water as an extender, organic solvents can, for example, also be used as auxiliary solvents. Liquid solvents include aromatics, such as xylene, toluene or alkylnaphthalenes, chlorinated aromatics and chlorinated aliphatic hydrocarbons, such as chlorobenzenes, chloroethylenes or methylene chloride, ali-phatic hydrocarbons, such as cyclohexane or paraffins, for example petroleum fractions, mineral and vegetable oils, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, as well as water.

As solid carriers there are suitable, for example, ammonium salts and ground natural minerals, such as kaolins, clays, talc, chalk, quartz, attapulgite, mont-morillonite or diatomaceous earth, and ground synthetic minerals, such as finely divided silica, alumina and silicates, as solid carriers for granules there are suitable: for example crushed and fractionated natural rocks such as calcite, marble, pumice, sepiolite and dolomite, as well as synthetic granules of inorganic and organic meals, and granules of organic material such as sawdust, coconut shells, maize cobs and tobacco stalks; as emulsifying and/or foam-forming agents there are suitable: for example nonionic and anionic emulsifiers, such as polyoxyethylene fatty acid esters, poly-oxyethylene fatty alcohol ethers, for example alkylaryl polyglycol ethers, alkylsulphonates, alkyl sulphates, aryl-sulphonates as well as protein hydrolysates; as dispersing agents there are suitable: for example lignin-sulphite waste liquors and methylcellulose.

Adhesives such as carboxymethylcellulose and natural and synthetic polymers in the form of powders, granules or latexes, such as gum arabic, polyvinyl alcohol and polyvinyl acetate, as well as natural phospholipids, such as cephalins and lecithins, and synthetic phospholipids, can be used in the formulations.

Colourants can also be included in the formulations. Non-limiting examples are inorganic pigments, such as iron oxide, titanium oxide and Prussian Blue, and organic dyestuffs, such as alizarin dyestuffs, azo dye-stuffs and metal phthalocyanine dyestuffs, and trace nutrients such as salts of iron, manganese, boron, copper, cobalt, molybdenum and zinc.

The formulations are prepared according to procedures which are conventional in the agricultural chemical art, but which are novel and important because of the presence therein of a combinations/composition of the present invention. Herbicidal combinations/compositions according to the invention can be applied in the form of ready mixes. Herbicidal compositions can also be formulated individually and mixed upon use, i.e. applied in the form of tank mixes.

Herbicidal compositions can be used as such or in the form of their formulations, for particular application purposes, in particular when applied post-emergence, formulations such as mineral or vegetable oils which are tolerated by plants or ammonium salts such as, for example, ammonium sulphate or ammonium thiocyanate, as further additives can be included.

Herbicidal compositions can be used as such, in the form of their formulations or in the forms prepared therefrom by dilution of a concentrated form, such as ready-to-use or concentrated solutions, suspensions, emulsions, powders, pastes and granules. They are used in the customary manner, for example by watering, spraying, atomizing, dusting or scattering. Herbicidal compositions according to the invention can be applied before and after the plants have emerged, that is to say pre-emergence and post-emergence. They can also be incorporated into the soil before, during or after sowing seeds of a crop. The invention also provides methods for controlling undesirable plants or vegetation. In one embodiment, a method includes applying to a crop where control of such vegetation is desired, an herbicidally effective amount of a composition. Such methods include a composition of the invention, optionally together with an adjuvant, an inert diluent or agriculturally acceptable carrier(s) suitable for use with an herbicide.

The acceptable carrier may be any one or a combination of adjuvants, co-solvents, surfactants, colorants, emulsifiers, thickeners, antifreeze agents, biocides, anti-foam agents, stabilizers, wetting agents or a mixture thereof which may be optionally added to the compositions of the present invention. The surfactants may be selected from non-ionic, anionic or cationic surfactants.

These combinations/compositions as described above may be applied to the locus of the weeds, in an herbicidally effective amount.

In an embodiment, the total amount of the shoot growth inhibitors herbicide in the composition is in the range of 0.1 to 99% by weight, preferably 0.2 to 90% by weight.

In an embodiment, the total amount of the second active or third active in the composition may be in the range of 0.1 to 99% by weight.

In an embodiment, the constituent herbicides of the composition of the present invention may be admixed in ratio of (1-80):(1-80) respectively.

In an embodiment the combinations/compositions of the present invention are applied at an application rate from about 0.001 kg a. i./ha to 5.0 kg a. i./ha, preferably from about 100 g a. i./ha to 2500 g a.i./ha, more preferably from about 100 g a. i./ha to 2000 g a.i./ha.

The herbicidal combination of the present invention maybe used to target weeds among the crops such corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, sugarcane etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

Typically, the target weeds is selected from Alopecurus myosuroides Huds. (blackgrass, ALOMY), Amaranthus palmeri (Palmer amaranth, AMAPA) Amaranthus viridis (slender amaranth, AMAVI), Avena fatua (wild oat, AVEFA), Brachiaria decumbens Stapf. or Urochloa decumbens (Stapf), Brachiaria brizantha or Urochloa brizantha, Brachiaria platyphylla (Groseb.) Nash or Urochloa platyphylla (broadleaf signalgrass, BRAPP), Brachiaria plantaginea. or Urochloa plantaginea (alexandergrass, BRAPL), Cenchrus echinatus (southern sandbur, CENEC), Digitaria horizontalis Willd. (Jamaican crabgrass, DIGHO), Digitaria insularis (sourgrass, TRCIN), Digitaria sanguinalis (large crabgrass, DIGSA), Echinochloa crus-galli (barnyardgrass, ECHCG), Echinochloa colonum (junglerice, ECHCO), Eleusine indica Gaertn. (goosegrass, ELEIN), Lolium multiflorum Lam. (Italian ryegrass, LOLMU), Panicum dichotomiflorum Michx. (fall panicum, PANDI), Panicum miliaceum L. (wild-proso millet, PANMI), Sesbania exaltata (hemp sesbania, SEBEX), Setaria faberi Herrm. (giant foxtail, SETFA), Setaria viridis (green foxtail, SETVI), Sorghum halepense (Johnsongrass, SORHA), Sorghum bicolor, Moench ssp., Arundinaceum (shattercane, SORVU), Cyperus esculentus (yellow nutsedge, CYPES), Cyperus rotundus (purple nutsedge, CYPRO), Abutilon theophrasti (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida (giant ragweed, AMBTR), Anoda cristata (spurred anoda, ANVCR), Asclepias syriaca (common milkweed, ASCSY), Bidens pilosa (hairy beggarticks, BIDPI), Borreria species (BOISS), Borreria alata or Spermacoce alata Aubl. or Spermacoce latifolia (broadleaf buttonweed, BOILF), Chenopodium album L. (common lambsquarters, CHEAL), Cirsium arvense (Canada thistle, CIRAR), Commelina benghalensis (tropical spiderwort, COMBE), Datura stramonium (jimsonweed, DATST), Daucus carota (wild carrot, DAUCA), Euphorbia heterophylla (wild poinsettia, EPHHL), Euphorbia hirta or Chamaesyce hirta (garden spurge, EPHHI), Euphorbia dentata Michx. (toothed spurge, EPHDE), Erigeron bonariensis or Conyza bonariensis (hairy fleabane, ERIBO), Erigeron canadensis or Conyza canadensis (horseweed, ERICA), Conyza sumatrensis (tall fleabane, ERIFL), Helianthus annuus (common sunflower, HELAN), Jacquemontia tamnifolia (smallflower morningglory, IAQTA), Ipomoea hederacea (ivyleaf morningglory, IPOHE), Ipomoea lacunosa (white morningglory, IPOLA), Ipomoea grandifolia, Lactuca serriola (prickly lettuce, LACSE), Portulaca oleracea (common purslane, POROL), Richardia species (pusley, RCHSS), Salsola tragus (Russian thistle, SASKR), Sida species (sida, SIDSS), Sida spinosa (prickly sida, SIDSP), Sinapis arvensis (wild mustard, SINAR), Solanum ptychanthum (eastern black nightshade, SOLPT), Tridax procumbens (coat buttons, TRQPR), Rumex dentatus (RUMDE) or Xanthium strumarium (common cocklebur, XANST).

According to an embodiment, the weeds targeted are grassy weeds and broad-leaved weeds.

In an embodiment, the weed removal is not restricted to crop land or agricultural land only. The weeds are targeted in non-agricultural areas such as, but not limited to, forestries, railways, infrastructure, amenities, companies, factories, roads and runways, sidewalks, highways, dividers, medians, pipelines, public utility lines, pumping stations, transformer stations, substations, around airports, electric utilities, commercial buildings, manufacturing plants, storage yards, rail yards, hangars, fence lines, parking lots, parkways, sedges, post-harvest crop lands, beneath greenhouse benches and around golf courses.

In an aspect, the present invention provides a method of controlling weeds or selective control or total kill of weeds at the locus, said method comprising applying to the locus present herbicidal combinations.

In another aspect, the present invention provides a method of controlling weeds at a locus, said method comprising applying to the locus a herbicidal combination comprising:
(a) a shoot growth inhibitor; and
(b) at least one second herbicide selected from root growth inhibitor, Protoporphyrinogen Oxidase (PPO) Inhibitors, Acetyl CoA Carboxylase
(ACCase) Inhibitors and photosystem II inhibitor.

Yet, another aspect of the present invention may provide a method of increasing yield in a crop by application of a combination comprising:
(a) a shoot growth inhibitor; and
(b) at least one second herbicide selected from root growth inhibitor, Protoporphyrinogen Oxidase (PPO) Inhibitors, Acetyl CoA Carboxylase (ACCase) Inhibitors and photosystem II inhibitor.

Another aspect of the present invention provides a method of improving the plant health, said method comprising application at the locus of the plant a combination comprising:
(a) a shoot growth inhibitor; and
(b) at least one second herbicide selected from root growth inhibitor, Protoporphyrinogen Oxidase (PPO) Inhibitors, Acetyl CoA Carboxylase (ACCase) Inhibitors and photosystem II inhibitor.

Another aspect of the present invention provides a method of improving the plant health, said method comprising application at the locus of the plant a combination comprising:
(a) a shoot growth inhibitor; and
(b) at least one second herbicide selected from root growth inhibitor, Protoporphyrinogen Oxidase (PPO) Inhibitors, Acetyl CoA Carboxylase (ACCase) Inhibitors and photosystem II inhibitor.

In one preferred embodiment, the shoot growth inhibitor is chloroacetamide compound present in the composition of present invention, preferably propisochlor.

The herbicide compositions of the present invention are synergistically effective in controlling weeds.

In an embodiment, the combinations of the present invention may be applied to the locus or to the crop/plant either simultaneously or separately or sequentially, such that the two or three herbicides may be applied in a tank mix or as a pre-mixed composition.

The present combinations/compositions can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

In an embodiment, there is provided a kit-of-parts comprising an instructions manual, said instructions manual comprising instructions directing a user to admix the components before being used.

In an embodiment, the components of the present invention may be packaged such that the chloroacetamide herbicide and at least one another herbicide defined above may be packaged separately and then tank mixed before the spraying.

In another embodiment, the components of the present invention may be packaged such that chloroacetamide herbicide and at least one another herbicide defined above may be packaged separately, whereas other additives are packaged separately, such that the two maybe tank mixed at the time of spraying.

In another embodiment, the components of the present invention may be packaged as composition such that chloroacetamide herbicide and at least one another herbicide defined above are formulated into one composition and other additives are packaged separately, such that the two maybe tank mixed at the time of spraying.

The invention also provides methods for selective control of weeds. In one embodiment, a method includes contacting a composition of the invention onto a crop plant in need of weed control or at risk of undesirable weeds, in an amount effective to provide weed control in the crop.

Herbicidal activity of the compound combinations can be seen from the examples which follow. While the individual active compounds show less activity with regard to herbicidal activity, certain combinations have a herbicidal activity which exceeds a simple sum of the activity of the individual active compounds.

These combinations or compositions as described above may be applied to the weed or to locus of the weeds or to the plant/crop, in synergistically effective amount. It can be seen from the use examples herein below that the found herbicidal action of the active compound combinations according to the invention exceeds the calculated value, that is to say that the new active compound combinations have a synergistic effect in controlling weeds.

This effectiveness of all treatments can be evaluated according to Colby's equation. In the Colby's equation given below, E is the expected efficacy of combination of Propisochlor and another herbicide, X is the observed efficacy of Propisochlor and Y is the observed efficacy of other herbicide. Observed efficacy values i.e. X and Y are % weed control for Propisochlor and another herbicide. If observed efficacy of combination of Propisochlor and other herbicide is greater than its expected efficacy, then combination is determined to be synergistic. If observed efficacy is equal to or less than expected efficacy, then combination is determined to be non-synergistic.

Colby's equation E=X+Y−XY/100

The results of synergistic effects of the present combinations/compositions is represented in examples.

Unless otherwise defined, all technical and scientific terms used herein have the same meaning as commonly understood by one of ordinary skill in the art to which this invention belongs. Although methods and materials similar or equivalent to those described herein can be used in the practice or testing of the invention, suitable methods and materials are described herein.

As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth.

Specifically, the invention includes embodiments in which particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein. A number of embodiments of the invention have been described. Nevertheless, it will be understood that various modifications may be made without departing from the spirit and scope of the invention.

These and other advantages of the invention may become more apparent from the examples set forth herein below. These examples are provided merely as illustrations of the invention and are not intended to be construed as a limitation thereof.

Experiments were carried out to evaluate the efficacy of combinations of present invention.

### Example 1

Herbicidal activity of synergistic mixtures of the combinations of present invention is represented in below tables.

TABLE 1
Table 1: Efficacy of synergistic mixtures of Propisochlor
+ Flumioxazin was represented in table below.

| | | | % Weed control* | | |
|---|---|---|---|---|---|
| | Treatment | Dose | Brachiaria | Brachiaria | Commelina |
| Sr. No. | Component | g ai/ha | plantaginea | decumbens | benghalensis |
| 1. | Propisochlor | 1200 | 84.50 | 85.75 | 92.00 |
| 2. | Flumioxazin | 50 | 53.75 | 63.75 | 90.25 |
| 3. | Propisochlor + | 1200 + 50 | 96.50 | 97.00 | 99.25 |
| | Flumioxazin | | | | |

*after 35 days after administration against 3 weeds.

TABLE 2
Table 2: Herbicidal activity of synergistic
mixtures of Propisochlor + Sulfentrazone.

| | | | % Weed control * | | |
|---|---|---|---|---|---|
| | Treatment | Dose | Eleusine | Ipomoea | Spermacoce |
| Sr. No. | Component | g ai/ha | indica | hederifolia | verticillata |
| 1. | Propisochlor | 525 | 99.75 | 26.25 | 92.75 |
| 2. | Propisochlor | 675 | 100.00 | 27 | 95.75 |
| 3. | Sulfentrazone | 75 | 90.00 | 98.00 | 92.25 |
| 4. | Propisochlor + | 525 + 75 | 100.00 | 100.00 | 99.50 |
| | Sulfentrazone | | | | |
| 5. | Propisochlor + | 675 + 75 | 100.00 | 100.00 | 100.00 |
| | Sulfentrazone | | | | |

* % after 35 days after administration against 3 weeds.

TABLE 3
Table 3: Herbicidal activity of synergistic mixtures
of Propisochlor + Haloxyfop-p-methyl.

| | | | % Weed control * |
|---|---|---|---|
| | Treatment | Dose | Brachiaria |
| Sr. No. | Component | g ai/ha | decumbens |
| 1. | Propisochlor | 1080 | 92.0 |
| 2. | Haloxyfop-p-methyl | 62.1 | 11.3 |
| 3. | Propisochlor + | 1080 + 62.1 | 96.3 |
| | Haloxyfop-p-methyl | | |

* % after 35 days after administration against Brachiaria decumbens.

TABLE 4
Table 4: Herbicidal activity of synergistic
mixtures of Propisochlor + Clethodim.

| | | | % Weed control* |
|---|---|---|---|
| | Treatment | Dose | Cenchrus |
| Sr. No. | Component | g ai/ha | echinatus |
| 1. | Propisochlor | 540 | 71.3 |
| 2. | Propisochlor | 1080 | 88.8 |
| 3. | Clethodim | 120 | 0.0 |
| 4. | Propisochlor + | 540 + 120 | 91.3 |
| | Clethodim | | |
| 5. | Propisochlor + | 1080 + 120 | 95.8 |
| | Clethodim | | |

*% after 35 days after administration against Cenchrus echinatus.

TABLE 5
Table 5: Herbicidal activity of synergistic mixtures
of Propisochlor + Quizalafop-p-ethyl.

| | | | % Weed control * |
|---|---|---|---|
| | Treatment | Dose | Cenchrus |
| Sr. No. | Component | g ai/ha | echinatus |
| 1. | Propisochlor | 540 | 71.3 |
| 2. | Propisochlor | 1080 | 88.8 |
| 3. | Quizalafop-p-ethyl | 87.5 | 77.5 |
| 4. | Propisochlor + | 540 + 87.5 | 100.0 |
| | Quizalafop-p-ethyl | | |
| 5. | Propisochlor + | 1080 + 87.5 | 100.0 |
| | Quizalafop-p-ethyl | | |

* % after 35 days after administration against Cenchrus echinatus.

### Example 2

TABLE 6
Table 6: Herbicidal activity of synergistic
mixtures of Propisochlor + Hexazinone.

| | | | % Weed control* | |
|---|---|---|---|---|
| | Treatment | Dose | Brachiaria | Commelina |
| Sr. No. | Component | g ai/ha | decumbens | benghalensis |
| 1. | Propisochlor | 1080 | 75.0 | 90.8 |
| 2. | Hexazinone | 125 | 11.3 | 45.0 |
| 3. | Propisochlor + | 1080 + 87.5 | 80.0 | 95.3 |
| | Hexazinone | | | |

*% after 35 days after administration against 2 weeds.

TABLE 7
Table 7: Herbicidal activity of synergistic
mixtures of Propisochlor + Diuron.

| | | | % Weed control * |
|---|---|---|---|
| | Treatment | Dose | Ipomoea |
| Sr. No. | Component | g ai/ha | grandifolia |
| 1. | Propisochlor | 540 | 7.5 |
| 2. | Propisochlor | 1080 | 22.5 |
| 3. | Diuron | 500 | 0.0 |
| 4. | Propisochlor + | 540 + 500 | 15.0 |
| | Diuron | | |
| 5. | Propisochlor + | 1080 + 500 | 33.8 |
| | Diuron | | |

* % after 21 days after administration against Ipomoea grandifolia.

TABLE 8
Table 8: Herbicidal activity of synergistic
mixtures of Propisochlor + Diuron.

| | | | % Weed control * |
|---|---|---|---|
| | Treatment | Dose | Commelina |
| Sr. No. | Component | g ai/ha | benghalensis |
| 1. | Propisochlor | 1080 | 90.8 |
| 2. | Diuron | 500 | 0 |
| 3. | Propisochlor + | 1080 + 500 | 96.3 |
| | Diuron | | |

* % after 35 days after administration against Commelina benghalensis.

TABLE 9
Table 9: Herbicidal activity of synergistic mixtures of Propisochlor + Diuron.

| | | | % Weed control * | | |
|---|---|---|---|---|---|
| | Treatment | Dose | Brachiaria | Cenchrus | Ipomoea |
| Sr. No. | Component | g ai/ha | decumbens | echinatus | grandifolia |
| 1. | Propisochlor | 540 | 68.8 | 91.8 | 0.0 |
| 2. | Diuron | 1000 | 3.8 | 5.0 | 0.0 |
| 3. | Diuron | 2000 | 12.5 | 1.3 | 0.0 |
| 4. | Propisochlor + | 540 + 1000 | 75.0 | 95.8 | 22.5 |
| | Diuron | | | | |
| 5. | Propisochlor + | 540 + 2000 | 80.8 | 100 | 21.3 |
| | Diuron | | | | |

* % after 35 days after administration against 3 weeds.

TABLE 10
Table 10: Herbicidal activity of synergistic
mixtures of Propisochlor + Tebuthiuron.

| | | | % Weed control * | |
|---|---|---|---|---|
| | Treatment | Dose | Commelina | Ipomoea |
| Sr. No. | Component | g ai/ha | benghalensis | grandifolia |
| 1. | Propisochlor | 1080 | 90.8 | 45.0 |
| 2. | Tebuthiuron | 400 | 0.0 | 12.5 |
| 3. | Propisochlor + | 1080 + 400 | 98.8 | 61.3 |
| | Tebuthiuron | | | |

* % after 35 days after administration against 2 weeds.

TABLE 11
Table 11: Herbicidal activity of synergistic
mixtures of Propisochlor + Trifluralin.

| | | | % Weed control* |
|---|---|---|---|
| | Treatment | Dose | Ipomoea |
| Sr. No. | Component | g ai/ha | grandifolia |
| 1. | Propisochlor | 540 | 53.8 |
| 2. | Propisochlor | 1080 | 55.50 |
| 3. | Trifluralin | 300 | 0.0 |
| 4. | Propisochlor + | 540 + 300 | 55.0 |
| | Trifluralin | | |
| 5. | Propisochlor + | 1080 + 300 | 61.3 |
| | Trifluralin | | |

*% after 35 days after administration against Ipomoea grandifolia.

Thus, it is concluded that combinations or compositions of the present invention are effective for targeted weed control.

1. A herbicidal combination comprising:
at least one shoot growth inhibitor; and
at least one root growth inhibitor or at least one cell membrane disruptor.

2. The combination according to claim 1, wherein said at least one shoot growth inhibitor is chloro acetamide compound.

3. The combination according to claim 1, wherein said at least one cell membrane disruptor is selected from the group consisting of a Protoporphyrinogen Oxidase inhibitor, an acetyl CoA Carboxylase inhibitor, and a photo system II inhibitor.

4. The combination according to claim 1, wherein the at least one root growth inhibitor is microtubule assembly inhibitor.

5. The combination according to claim 4 wherein said microtubule assembly inhibitor is selected from the group consisting of a benzamide herbicide, a benzoic acid herbicide, a nitroaniline herbicide, and a pyridine herbicide.

6. The combination according to claim 3, wherein said Protoporphyrinogen Oxidase inhibitor comprises one or more herbicides selected from the group consisting of a diphenylether herbicide, a N-phenylphthalimide herbicide, a phenylpyrazole oxadiazole herbicide, a thiadiazole herbicide, a triazolinone herbicide, an oxazolidinedione herbicide, and a pyrimidinedione herbicide.

7. The combination according to claim 6, wherein said Protoporphyrinogen Oxidase inhibitor comprises one or more herbicides selected from the group consisting of acifluorfen, fomesafen, lactofen, flumiclorac, flumioxazin, Orizalina, carfentrazone, fluthiacet-ethyl and azafenidin, benzfendizone, bifenox, butafenacil, carfentrazone, carfentrazone-ethyl, chlomethoxyfen, cinidon-ethyl, fluazolate, flufenpyr-ethyl, flumiclorac-pentyl, fluoroglycofen-ethyl, fluthiacet-methyl, fomesafen, halosafen, lactofen, oxadiargyl, oxadiazon, oxyfluorfen, pentoxazone, profluazol, pyraclonil, pyraflufen-ethyl, thidiazimin, trifludimoxazin, and tiafenacil.

8. The combination according to claim 3, wherein said acetyl-CoA carboxylase inhibitor comprises one or more herbicides selected from the group consisting of aryloxyphenoxypropionates, cyclohexanediones, and phenylpyrazoline.

9. The herbicidal combination according to claim 8, wherein said acetyl-CoA carboxylase inhibitor comprises one or more herbicides selected from the group consisting of clodinafop-propargyl, cyhalofop-butyl, diclofop-methyl, fenoxaprop-P-ethyl, fluazifop-P-butyl, haloxyfop-etotyl, haloxyfop-methyl, haloxyfop-P-methyl, quizalofop-P-ethyl, propaquizafop, metamifop, quizalofop-P-tefuryl, alloxydim, butroxydim, clethodim, cycloxydim, profoxydim, sethoxydim, tepraloxydim, tralkoxydim, and pinoxaden.

10. The herbicidal combination according to claim 3, wherein said photosystem II inhibitor comprises one or more herbicides selected from the group consisting of phenylcarbamate herbicides, triazine herbicides, triazinone herbicides, uracil herbicides, benthiadiazole herbicides, nitrile herbicides, urea herbicides, and thiadiazolylurea herbicides.

11. The herbicidal combination according to claim 10, wherein said photosystem II inhibitor comprises one or more herbicides selected from the group consisting of barban, BCPC, carbasulam, carbetamide, CEPC, chlorbufam, chlorpropham, CPPC, desmedipham, phenisopham, phenmedipham, phenmedipham-ethyl, propham, swep, fucaojing, trihydroxytriazine, atrazine, chlorazine, cyanazine, cyprazine, eglinazine, ipazine, mesoprazine, procyazine, proglinazine, propazine, sebuthylazine, simazine, terbuthylazine, trietazine, indaziflam, triaziflam, atraton, methometon, prometon, secbumeton, simeton, terbumeton, ametryn, aziprotryne, cyanatryn, desmetryn, dimethametryn, methoprotryne, propmetryn, simetryn, terbutryn, ametridione, amibuzin, ethiozin, hexazinone, isomethiozin, metamitron, metribuzin, trifludimoxazin, benzfendizone, bromacil, butafenacil, flupropacil, isocil, lenacil, terbacil, tiafenacil, bromobonil, bromoxynil, chloroxynil, cyclopyranil, dichlobenil, iodobenil, ioxynil, pyraclonil, buthiuron, ethidimuron, tebuthiuron, thiazafluron, thidiazuron, benazolin, benzthiazuron, fenthiaprop, mefenacet, methabenzthiazuron, bentazone, bentazone-sodium, anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiruon, methyldymuron, metobenzuron, metobromuron, metoxuron, monolinuron, monuron, neburon, parafluron, phenobenzuron, siduron, tetrafluron, thidiazuron, bentazone, and bentazone-sodium.

12. A herbicidal composition comprising herbicidal combination of:
at least one shoot growth inhibitor;
at least one herbicide selected from root growth inhibitor or at least one cell membrane disruptor, and
at least one agrochemically acceptable excipient.

13. A method of controlling weeds, said method comprising applying to weed, to their locus, or to crop a herbicidal combination comprising:
(a) at least one shoot growth inhibitor; and
(b) at least one root growth inhibitor or at least one cell membrane disruptor.

14. The method according to claim 13,
wherein said at least one shoot growth inhibitor is a chloro acetamide compound;
wherein said at least one root growth inhibitor is a microtubule assembly inhibitor; and
wherein said at least one cell membrane disruptor is selected from the group consisting of a Protoporphyrinogen Oxidase inhibitor, an acetyl CoA Carboxylase inhibitor, and a photo system II inhibitor.

15. The method according to claim 13, wherein said at least one shoot growth inhibitor and said at least one root growth inhibitor or said at least one cell membrane disruptor are applied simultaneously, separately, or sequentially in any sequence for synergistic control of weeds.

16. (canceled)

17. A method for controlling undesirable plants or vegetation, comprising applying to a crop where control of such plants or vegetation is desired, an herbicidally effective amount of the composition according to claim 12.
